(19) United States
(12) Patent Application Publication
(10) Pub. No.: US 2014/0282520 A1
(43) Pub. Date: Sep. 18, 2014

(54) PROVISIONING VIRTUAL MACHINES ON A PHYSICAL INFRASTRUCTURE

(71) Applicant: Navin Sabharwal, New Delhi (IN)

(72) Inventor: Navin Sabharwal, New Delhi (IN)

(21) Appl. No.: 13/841,563

(22) Filed: Mar. 15, 2013

(51) Int. Cl. G06F 9/455

(52) U.S. Cl. CPC G06F 9/455
USPC 718/1

(57) ABSTRACT

Example methods and systems provide for the provisioning of virtual machines on a physical infrastructure based on actual past resource usage of a plurality of virtual machines currently deployed on the physical infrastructure. Upon receiving a request for a new virtual machine based on specified resource requirements, actual usage data that indicate past resource usage of the plurality of current virtual machines are accessed, and provisioning parameters for the new virtual machine are calculated based at least in part on the actual usage data and the specified resource requirements.

### BACKGROUND

A virtual machine (VM) is a software implementation that executes programs in a manner similar to a physical machine, e.g. similar to a physical computer. VMs are sometimes separated into two categories, based on their use and degree of correspondence to a real machine. A system virtual machine provides a system platform which supports the execution on the VM of an operating system (OS) separate from any operating system of a host server on which the VM is implemented. In contrast, a process virtual machine is designed to run a single program, which means that it supports a single process. This disclosure pertains to system virtual machines, and the term “VM” or “virtual machine” means a system virtual machine.

VMs may be employed in distributed computing services and other types of resource on-demand systems, to provide scalable means for using computer resources to meet computing demands of users. For example, a VM may provide a remote desktop to a user who accesses the VM remotely, e.g. via a distributed network such as the Internet. Display and user input devices for interacting with the Remote Desktop are located with the user, away from computing resources that may be provided by a VM host system having a physical infrastructure including multiple host servers. The user may use a “thin client” that may, for example comprise a small computer with peripherals such as a monitor, keyboard, mouse and other interfaces. The thin client may run software that allows displaying and interacting with the desktop, which runs remotely on the virtual machine. This has obvious advantages for users of the distributed resource service as far as resource planning and resource support management is concerned.

More than one VM can be provided by a single host server, but the allocation of resources for multiple VMs on a physical infrastructure can be complex and unpredictable because of varying user requirements as to, e.g., the processing power, amount of memory, and graphics requirements, that are to be allocated to respective VMs.

Enterprises that provide extended cloud services can benefit greatly from increasing resource utilization and infrastructure efficiencies, particularly as far as the handling of demand spikes is concerned.

Presently, there are various methods that involve movement of virtual machines from one underlying infrastructure position to another when required, e.g., due to increased demand for resources. These provisioning methods are often executed post-implementation and ad hoc.

### BRIEF DESCRIPTION OF DRAWINGS

Some embodiments are illustrated by way of example and not limitation in the figures of the accompanying drawings, in which like reference numerals indicate like components. In the drawings:

FIG. 1 is a schematic diagram of an example embodiment of a VM provisioning.

FIG. 2 is a schematic flow chart of a method of provisioning VMs on a physical infrastructure in accordance with an example embodiment.

FIG. 3 is a schematic diagram of an example environment in which a VM provisioning system may be provided in accordance with some example embodiments.

FIG. 4 is a schematic block diagram of components of an example embodiment of a VM provisioning application(s) to form part of a VM provisioning system.

FIG. 5 is a high-level schematic diagram of another example embodiment of a VM provisioning system.

FIG. 6 is a high-level schematic flow chart that illustrates another example embodiment of a method of provisioning VMs on a physical infrastructure.

FIG. 7 is a diagrammatic representation of a machine in the example form of a computer system within which a set of instructions for causing the machine to perform any one or more of the methodologies discussed herein may be executed.

### DETAILED DESCRIPTION

Example methods and systems to provision VMs on a physical infrastructure will now be described. In the following description, for purposes of explanation, numerous specific details are set forth in order to provide a thorough understanding of example embodiments. It will be evident, however, to one skilled in the art that many other embodiments that fall within the scope of the present disclosure may be practiced without these specific details.

Some of the example embodiments that follow describe automated provisioning of multiple VMs on a physical infrastructure based on actual past resource usage of VMs currently hosted on the physical infrastructure. For example, to determine the available resources on respective host servers that together provide the physical infrastructure for a hosting platform, the actual resource usage of all of the VMs hosted on a particular host server may be taken into account, instead of provisioning new VMs based on resource volumes requested and/or allocated to the respective currently implemented VMs.

The method and system may also perform timeslot-based provisioning. A new VM requests may thus specify a particular time period that serves as a deployment window in a regularly repeating scheduling period, e.g. a day. Resource usage and host server resource availability may be determined over the scheduling period, e.g., determining daily distribution patterns for resource usage by the implemented VMs.

Such timeslot-based provisioning facilitates the hosting of multiple VMs on a single host server, even if the total resources to be used by the multiple VMs (if they were to be implemented simultaneously) exceed a resource capacity of the host server.

The method and system may also comprise automated provisioning of VMs (e.g. by calculating a suitability factor for respective candidate VMs) such that the provisioning is biased against provisioning a VM on an “unused host server” that does not currently host any VMs. Thus, the method may be slanted towards maximizing the number of unused host servers.

Instead, or in addition, the provisioning of the VMs may be slanted towards minimizing unscheduled movement of VMs from one server to another. The provisioning may thus have a built-in bias towards hosting each VM on only one host server.

### Example System

FIG. 1 is a schematic representation of a host system 100 comprising a plurality of physical host servers 104 on which multiple virtual machines (VMs) 107 may be deployed. Each VM 107 comprises execution of software on one or more associated host servers 104 to provide a software implementation of a machine (e.g., a computer) that can execute programs in a manner similar to a physical machine.

Each of the host servers 104 has a limited resource capacity, while each VM 107 has certain resource requirements to sustain its deployment. The allocation of VMs 107 to the host servers 104, e.g. to manage resource consumption and operation of the host system 100, is therefore pertinent to capacity of the VM host system 100, and to effective service delivery to a plurality of clients associated with respective client machines 119. To this end, a VM provisioning system 111 may serve to provision deployment of the VMs 107 on a physical infrastructure provided by the host servers 104 of the host system 100.

The VM provisioning system 111 may include a VM resource database 113 that may store information regarding components of the host system 100. In this example, the VM resource database 113 serves, inter alia, as a memory to store actual usage data for already provisioned VMs 107, indicating past resource usage of the respective current VMs 107.

The actual usage data may comprise time-distribution information on respective past usage parameters, for example reflecting the actual amount of processing capacity, memory usage, storage usage, and/or bandwidth consumption of each current VM 107 separately, for each time unit of the scheduling period (e.g., for each hour of the day). Such past usage information may be condensed or compacted to indicate a single daily distribution for each current VM 107, for example by reflecting the maximum, median, or average resource consumption for each hour of the day, depending on administrative preferences or settings. In this example, the actual usage data reflects maximum past resource usage for each parameter, for each hour of the day.

The VMs 107 shown in FIG. 1 have already been deployed on host system 100 and are executed by one or more host servers 104 on an ongoing basis. To distinguish between VMs that are already deployed and VMs for which provisioning parameters are to be calculated, the already provisioned VMs 107 are occasionally referred to herein as current VMs, while VMs that are the subject of automated provisioning operations are sometimes referred to herein as new VMs or target VMs.

In this example embodiment, provisioning is performed and calculated based on a regular, repeating scheduling period of 24 hours, e.g. coinciding with a calendar day, therefore comprising a daily scheduling period. The daily scheduling period is divided into multiple time units, in this example being hourly time units. Provisioning of the VMs 107 is thus implemented on an hourly basis of a daily interval. Note that different granularities or scheduling intervals, both of the scheduling period and of the time units, may be employed in other embodiments.

Note that some of the current VMs 107 are provisioned on only one host server 104 (e.g., VM 107a and VM 107b), while other VMs 107 (such as VM 107e) are provisioned on more than one host server 104. In this example, the VMs 107 are generally provisioned on a single host server 104 if that host server 104 has sufficient resources for full implementation of the VM 107. If, however, the relevant host server 104 has enough available resources to deploy the VM 107 for only a part of a deployment window (in this example being a daily deployment window comprising or a part of the day), then the VM 107 may be provisioned for deployment on one host server 104 for part of its deployment window, and may be deployed on one or more other host servers 104 for the remainder of the deployment window. For example, VM 107e may be scheduled for deployment on host server 104b from 10 AM to 1 PM every day, and on host server 104c from 1 PM to 8 PM every day.

The VM 107e is thus regularly moved from one host server (104b) to another host server (104c) during the daily scheduling period, for example by means of a vMotion utility that executes live migration from one physical server to another. Note that movement of the VM (e.g., 107e) is such that there is usually no noticeable interruption of service to a user that accesses the VM 107e from an associated client machine 119. In some instances where a distinction between, (a) VMs 107 that are deployed on one host server 104 only and (b) VMs 107 that are provisioned for regular movement is emphasized, the latter are occasionally referred to herein as multi-server VMs or multi-server deployments. In contrast, host servers 104 that contribute to the hosting of multi-server VMs 107 may be referred to as part-time host servers 104, as it relates to their relationship with the relevant multi-server VM 107.

At least some of the VMs 107 may be used by one or more associated clients by communication of the VMs 107 with corresponding client machines 119 that may be coupled to the host system 100 directly or via a network, such the Internet 115.

When deployment of a new VM 107 is desired, a user may send a VM request 123 to the VM provisioning system 111, e.g. via the network 115. The VM request 123 may include resource requirement attributes that indicate resource requirements for the requested VM. For clarity of description, a particular VM that is the subject of a provisioning operation is sometimes referred to herein as a target VM. Responsive to the VM request 123, the requested VM is this the target VM of a provisioning operation performed by the VM provisioning system 111, to calculate resource provisioning parameters that may include one or more designated host servers 104 on which the target VM is to be deployed in one or more intervals that together cover the deployment window.

The resource requirement attributes indicated by the VM request 123 may include a deployment window for which the target VM is to be operable, e.g. a specified timeslot comprising a part of the day. For example, a VM request 123 that indicates a deployment window of, say, 6 PM to 8 PM, means that the target VM is to be provided between 6 PM and 8 PM, every day (or, in some embodiments, for multiple specified days).

The resource requirement attributes may further include minimum resource capacities that are needed in the deployment window. In this example, the resource requirement attributes may comprise processing capacity (hereafter “CPU”), random access memory (RAM) capacity (hereafter “memory”), storage memory capacity (hereinafter “storage”), and/or bandwidth requirements (hereafter “bandwidth”).

In some embodiments, VM provisioning may be performed not only with respect to new VMs responsive to VM requests 123, but routine or ongoing recalculation of current VM provisioning parameters may be performed, e.g. to optimize resource usage of the already deployed VMs 107.

### Example Method

FIG. 2 is a flowchart that shows, at a relatively detailed level, an example method 200 to provision VMs 107 on a physical infrastructure. The example method 200 is described as being implemented by the example host system 100 of FIG. 1. Reference is also made to various hardware-implemented modules of an example VM provisioning system 111 described later herein with reference to FIGS. 3 and 4. Like numerals indicate like parts in the figures, unless otherwise indicated.

The method 200 may comprise discovering operating parameters of various elements of the host system 100 on an ongoing basis, and updating actual usage data of the respective host servers 104 and current VMs 107 in the VM resource database 113. Such discovery of actual resource consumption may be performed, in this example embodiment, by a data mining utility provided, e.g., by hardware-implemented data mining module 431 of the VM provisioning system 111 (FIG. 4), and may comprise, at 203, routinely initiating data mining of host system 100. As used herein, “routinely” and its derivatives mean an operation that is performed automatically and that automatically repeated indefinitely. Routine data mining may thus comprise at regular intervals, intermittently, or continuously investigating, polling, and/or querying system element or network component logs, records, and/or embedded measuring utilities. The data mining may include receiving auto-generated reports from respective components of the host system 100. In some embodiments, data mining operations may be performed, at least in part, by using system management agents of the host system 100.

Routine discovery of operating parameters of the host system 100 may comprise, at 209, examining the amount of resources consumed by a particular current VM 107 during a particular time interval on a particular host server 104. In this example, each time interval is an hour of the day. This operation (at 209) is repeated, at 207, for every current VM 107 on the particular host server 104, thus producing information on actual resource usage for the relevant hour by the individual current VMs 107 on the host server 104, and, by extension providing information on overall resource usage for the relevant hour on the particular host server 104.

The resource usage investigation (at 207 and 209) may be repeated, at 205, for every host server 104 and for every hour of the day, to produce time-differentiated actual usage data for the host server 104 for a whole day. Thereafter, the data mining module 431 may update the VM resource database 113, at 213, to promote currency of actual usage data in the VM resource database 113 and to limit the likelihood of provisioning by the VM provisioning system 111 based on stale actual usage data. As mentioned earlier, newly gathered usage data may be combined in the VM resource database 113 with earlier usage data in a selected mathematical operation, to provide a single daily time-distribution usage profile for each current VM 107 and/or each host server 104.

Automated calculation of provisioning parameters based on actual usage data for one or more target VMs may be triggered in a number of ways, for example by: (a) reception of a new VM request 123, at 215; (b) reception of an alarm, at 285, indicating a resource limit violation or a risk of resource limit violation; and (c) routine recalculation of already provisioned VMs 107, triggered at 259. These scenarios are not an exhaustive list of possible uses of one example embodiment of a method to provision VMs on a physical infrastructure, and the above-mentioned scenarios will now be described in turn below.

First, a VM may be provisioned in an automated operation responsive to receiving, at 215, a VM request 123 including resource requirement attributes that indicates resource requirements for a requested target VM to be deployed on the host system 100. The resource requirements of the VM request 123 may comprise the particular deployment window that specifies a defined portion of the scheduling period for which hosting of the target VM is required. In this example, the deployment window may comprise a daily timeslot, specifying one or more spans of successive hours of the day.

The resource requirements indicated by the VM request 123 may further comprise resource consumption requirements for the target VM, for example specifying limits or caps for consumption of one or more types of resources. The resource types for which values are specified in the VM request 123 may correspond to the actual usage properties for which information is gathered and stored in the VM resource database 113, in this example comprising CPU, memory, storage, and bandwidth. Often, pricing of VM hosting services are linked to the size of the requested resource caps, so that clients are incentivized to request modest or at least realistic resource volumes.

Automated provisioning of the target VM (e.g., to designate one or more host servers 104 that are reserved for hosting the target VM for associated intervals) is then performed based on, at least, (a) the specified resource requirements of the target VM and (b) the actual usage data of the plurality of current VMs 107.

In this embodiment, the automated provisioning may be performed by a hardware-implemented provisioning module 411 (FIG. 4) forming part of the VM provisioning system 111.

After receiving the VM request 123, the actual usage data may be accessed and processed to generate, at 217, a list of candidate host servers 104 for the target VM. In this example, the list is initially generated to include only those host servers 104 can serve as a sole host for the target VM, requiring no daily movement between two or more part-time host servers 104. The candidate list may thus initially include each host server 104 that has sufficient available resources throughout the whole of the target deployment window to satisfy the requested resource requirements

In this example, the candidate list may be generated by a hardware-implemented list generator 413 (FIG. 4) forming part of the provisioning module 411. Generating the list of candidate host servers 104 may include determining the available resources on the respective host servers 104 for each hour of the deployment window, e.g., by determining the difference between the resource capacity of the server and the cumulative resource consumption of all current VMs 107 deployed on that host server 104. The method 200 may thus comprise, for each hour of the deployment window (or for each hour of the day, if required), and for each host server 104, and for each resource type, determining the sum of the actual resource usage by all the current VMs 107 on the host server 104, and subtracting the sum values thus obtained from the respective resource capacities of host server 104 (e.g., the amount of the relevant resource that the host server 104 can provide when there are no VMs deployed thereon).

If the available capacity for any one of the resource types on a particular host server 104 is smaller than the resource requirements of the target VM for any hour in the deployment window, then that host server 104 is excluded from the candidate list. For ease of description, host servers 104 that are included in the list may be referred to herein as “potential host servers” or “candidate host servers.”

Note that initial exclusion from the candidate list of any host server 104 that is unable to host the target VM for the entire deployment window has the effect of, at least initially, limiting provisioning to potential full-time host servers 104.

If no such single host server 104 on which the target VM can be provisioned is found, then the provisioning operation may be extended also to consider potential part-time host servers 104 (as will be described at greater length later herein). The provisioning operation is thus biased against scheduling daily movement of the target VM from one host server 104 to another.

After generating the initial list of candidate host servers 104, at 217, it may be determined, at 219, whether or not the list is an empty set. If the determination is positive, it means that none of the host servers 104 of the host system 100 has sufficient available resources to host the target VM for the whole of the deployment window. In such a case, the method 200 may comprise performing automated provisioning of the target VM on two or more part-time host servers 104. Provisioning such a multi-server deployment will be described later. For clarity of illustration, the flowchart of FIG. 2 indicates process flow of operations pertaining to calculation of a single-server deployment with solid flow lines, while process of operations pertaining to calculation of a multi-server deployment is indicated with dashed flow lines. Note, however, that process flow that is common to both calculations is also indicated with solid flow lines.

For the moment, however, consider the situation where the initial list of candidate host servers 104 has one or more members, so that the determination at 219 is negative. It may thereafter be determined, at 221, whether or not the candidate host list 104 has only one member. If the determination at 221 is positive, it means that only one host server 104 has been identified that is capable of hosting the target VM for the entire deployment window. The solitary candidate host server 104 is then, at 223, automatically selected as the designated host server 104 on which the target VM 107 is to be deployed, and the automated provisioning operation is concluded.

If, however, there is more than one candidate host server 104 in the initial list, the method 200 may include, at 225, removing from the candidate host list one or more host servers 104 that are currently unused (in that no previously provisioned VMs 107 are currently deployed thereon). In this manner, the example method 200 gives preference to host servers 104 that are already partially used, so that calculation of the provisioning parameters is biased against provisioning the target VM on a host server 104 on which no current VM 107 is provisioned.

Note that the operation, at 225, of removing unused host servers 104 from the candidate list, in this example, comprises removing any subset of unused host servers 104 from the candidate list. If, therefore, the candidate list consists exclusively of unused host servers 104, then none of those host servers 104 is removed from the list, to prevent depopulation of the candidate host list.

Appreciate that, if all unused host servers 104 were to be removed from the list unconditionally, regardless of whether or not the result would be to empty the candidate host list 104, then the target VM would in no circumstances be provisioned on an unused host server 104. In some embodiments, the provisioning calculation may in such cases first attempt provisioning a multi-server deployment on currently used host servers 104, and only responsive to determining that no such multi-server deployment is possible, would the target VM be provisioned on an unused host server 104. In such embodiments, the bias against deployment on an unused server therefore takes precedence over the bias against multi-server deployments. In the example method 200 shown in FIG. 2, however, preference is given to the built-in bias against scheduling daily movement of the target VM (which is inherent in a multi-server deployment), by preventing exclusion of all unused host servers 104, at 225.

Although not shown in the flowchart of FIG. 2, the candidate list may again be assessed after removal of the subset of unused servers to determine if a solitary candidate host server 104 remains and, if that is the case, provisioning the target VM on the solitary candidate host server 104, at 235.

The initial product of the list generator 413 at operation 225 may thus be identification of a plurality of host servers 104 that are capable of serving as a single server host to the target VM. A particular one of these candidate host servers 104 is to be designated for deployment of the target VM so that the required resources on the host server 104 during the daily deployment window may be reserved for the target VM. To this end, the method 200 may comprise determining a best fit for the target VM, e.g., by determining a most suitable host server 104 based on automated calculation, at 227, of a suitability factor for the respective candidate host servers 104.

In this example, the suitability factor may be calculated according to an algorithm that generally slants host selection towards candidate hosts that have less available resources. In some embodiments, the best fit host may be identified simply as the candidate host server 104 that has the least available resources in the deployment window.

However, in this example, the suitability factor is determined according to the formula,

SF=tₘₐₓ*D_{day}*D_{window}

where:
SF is a suitability factor that is inversely related to the suitability of the relevant candidate server, so that a lower SF indicates greater suitability for selection as host server;
Dday is the difference, for the whole day, between the total resources of the server and the total resource utilization by all the current VMs 107 on the server 104 and may thus be viewed as the total daily available resources for the host server 104;
Dwindow is the total available resources on the candidate host server 104 during the deployment window of the target VM; and
tmax is the largest continuous span (in hours) during a scheduling day for which the required resources are available on the candidate host server 104.

Note that D_{day} and tₘₐₓ are variables that do not pertain only to the target window for the target VM, but that these variables relate to usage of the candidate host server 104 throughout the day, including times outside the target deployment window.

In this example embodiment, calculation of the suitability factor, at 227 may be performed by a suitability calculator 419 (FIG. 4) forming part of the provisioning module 411. Note that the calculation may include accessing the VM resource database 113 and processing the relevant actual usage data to calculate the variables D_{day}, tₘₐₓ, and D_{window}.

Calculation of total resources and the total resource utilization (e.g., for determining D_{day} and/or D_{window}) may comprise summing the resources for respective hours. For example, a candidate host server 104 that has 2, 2, and 1 CPU units available for the three respective hours of a three-hour deployment window may be calculated to have (as it regards the CPU resource type) a D_{window} of 5. The resultant value may thus strictly be described as being measured in CPU unit.hours rather than in CPU units.

Cumulative values may likewise be found for each of the resource types (e.g., CPU, memory, storage, and bandwidth) and these cumulative values may, in turn, be added together to find a total resource value.

For example, if a two-hour deployment window applies to a candidate host server 104 having the following distribution of available resources (that is, resource capacity in excess of that which is consumed by all current VMs 107 deployed on it):

| | Hour 1 | Hour 2 |
|---|---|---|
| CPU | 2 | 1 |
| Memory | 4 | 4 |
| Storage | 3 | 2 |
| Bandwidth | 1 | 2 |

then the total available resources during the deployment window (D_{window}) is 16 units. D_{day} may be calculated in a similar manner, but applied to the whole day, not just to the deployment window.

Calculation of VM resources by performing mathematical operations on values for respective resource types by considering the units of the resource types (thus allowing, for example, summation of CPU units and memory units) is well known to persons of ordinary skill in the art, and will not be described at length herein.

Once suitability factors for all of the candidate host servers 104 on the candidate list have been calculated, a particular host server 104 is selected, at 229, as host of the target VM, based at least in part on the suitability factor. The provisioning parameters thus determined comprise identification of the designated host server 104, together with the timeslot and resource limits that are to be reserved for the target VM on the designated host server 104.

Returning now to the scenario in which no suitable single server host is found, at 219, the method 200 may comprise calculating and scheduling deployment of the target VM on two or more part part-time host servers 104 in distinct respective deployment intervals (e.g., timeslots) that together cover the deployment window of the target VM. This may be achieved, in this example, by calculating suitability factors of the candidate host servers 104 for each hour in the deployment window. An operation similar to that described above for the deployment window as a whole may thus be performed for each hour in the deployment window.

The example method 200 may thus include, at 231, dividing the deployment window into respective component hours, and at 217, generating a separate list of candidate part-time host servers 104 for each hour of the deployment window.

If it is determined, at 219, that the candidate list for any hour is an empty set, it means that there is at least one timeslot in the requested deployment window for which the host system 100 does not have the capacity, and the VM request 123 is denied, at 233.

Responsive to determining, at 221, that the list of candidate part-time host servers 104 for any hour has only one member, the solitary candidate host server 104 may be selected, at 235, as part-time host server for the target VM for that particular hour.

A subset of unused host servers 104 may again be moved from the candidate list, at 225. In this context, an unused device may have some embodiments comprise devices that unused during the hour under consideration, but in other embodiments unused devices may be devices that are unused for the whole of the day.

Thereafter, for each hour of the deployment window, the suitability factor is calculated for each candidate host server 104 remaining on the respective list of candidate host servers 104. This may be done similarly to the calculation of the suitability factors described above for a single server deployment, with the exception that D_{window} may be the available resources in the relevant server 104 during the particular hour under consideration, rather than being in the available resources during the deployment window.

A particular host server 104 may then be selected and reserved for each hour of the deployment window, based at least in part on the suitability factors of the respective candidate host servers 104 for the respective hours. Such automatic scheduling of deployment of the target VM on two or more part-time host servers 104 may be biased towards a deployment schedule that has fewer scheduled daily movements of the target VM between host servers 104, e.g. to minimize daily movement of the target VM.

In some embodiments, such scheduling to limit scheduled movement may comprise parsing the list of candidate host servers 104 and their associated suitability factors for the respective hours, to identify a deployment schedule having the smallest number of scheduled daily movements. The suitability factor may in such cases be of secondary importance relative to reducing scheduled vMotion, serving only as a tie-breaking factor if two or more potential schedules with an equal number of scheduled movements are identified. Indeed, some embodiments may provide for scheduling based exclusively on minimizing scheduled movement between host servers 104, in which case calculation of suitability factors may be omitted.

In the example embodiment of FIG. 2, automated scheduling of multi-server deployments with a built-in slant or bias towards limiting movement may comprise determining, at 237, whether selection of a host server 104 for the immediately preceding time unit (in this example, the preceding hour) has been made. If not, then a host server 104 for the hour under consideration may be selected, at 239, based on the suitability factor. The provisioning may thus automatically select that host server 104 which is on the list of candidate host servers for the relevant hour and which has the lowest calculated suitability factor for that hour.

If, however, a host server 104 has been selected for the previous hour, it may be determined, at 241, whether or not the designated host server 104 for the previous hour is capable of hosting the target VM for the relevant hour currently under consideration (i.e., the hour immediately following the “previous hour” discussed above) based on the available resources of the previous hour's host server 104, as indicated by the actual usage data.

If the previous hour's host server 104 is also capable of hosting the target VM for this hour (i.e., the hour under consideration), then the previous hour's host server 104 is also selected, at 243, as designated or reserved host server 104 for this hour, regardless of any other considerations, and regardless of the suitability factors of the relevant host servers 104. Thus, preference is given to host servers 104 that avoid scheduled movement of the target VM, and preference is given to the particular physical host server 104 which can host the target VM for a longer time.

Responsive, however, to determining, at 241, that the previous hour's designated host server 104 does not have the necessary available resources for the hour under consideration, the candidate part-time host server 104 with the smallest suitability factor is selected, at 239.

Operations 237 through 243 may be repeated for each hour of the deployment window. At the completion of this process, provisioning parameters for the target VM are produced, comprising identification of two or more designated part-time host servers 104, together with specification, for each designated part-time host server 104, of an interval for which requested resources on the relevant host server 104 are to be reserved for deployment of the target VM.

As mentioned previously, automated provisioning may be performed not only responsive to requests for new VMs, but also on a continuous basis for at least some of the current VMs 107. Note that such ongoing recalculation of provisioning parameters for the current VMs 107 are more likely to produce results different from initially calculated provisioning parameters when, as is the case in this example, the provisioning is based on actual resource usage of the current VMs 107 rather than requested resource volumes.

While continuous or periodic recalculation of the provisioning parameters may in some embodiments be performed for all current VMs 107 on the host system 100, the example method 200 comprises marking some of the current VMs 107 for exclusion from automatic re-provisioning calculations. In this example, current VMs 107 that are hosted by fully occupied host servers 104 are marked for exclusion from the re-provisioning consideration.

The method 200 may thus include, processing actual usage information of the host servers 104 (e.g., as established during the earlier-described data mining e.g., of operations 203 through 211) to determine, at 247, whether or not the total resources (i.e., its resource capacities when no VMs are hosted thereon) are substantially equal to the total resources actually consumed by all the current VMs 107 hosted thereon. In other words, it is determined, for each host server 104, at 247, whether or not it has substantially no available resources.

If the determination at 247 is negative, then the relevant host server 104 (and therefore the current VMs 107 provisioned thereon) is not marked. If, however, the determination is positive, then it may be determined, at 251, whether or not all the current VMs 107 on the relevant host server 104 are actually utilizing the resources which are reserved for them on the host server 104. If this is the case, it means that the host server 104 under consideration is optimized and that it may be excluded from continuous resource usage optimization effected by way of post-deployment provisioning calculation, and the host server 104 and/or its associated VMs 107 are marked, at 255. In other embodiments, identification of servers or VMs for marking may be based exclusively on establishing that the relevant host server 104 has no available resources.

In this example, server marking is implemented on a sub-daily timescale, e.g., on an hourly basis. The resource consumption and capacity of the host servers 104 and VMs 107 are thus assessed separately for each hour of the day, and marking of the host servers 104 is done separately for each hour of the day. A particular host server 104 may thus, for example, be marked for exclusion from routine recalculation or optimization for some hours of the day, but not for others.

Operations 247 through 255 may this example be performed by a hardware-implemented server marking module 429 form part of the provisioning module 411 (FIG. 4).

The VM provisioning system 111 may include a post-deployment provisioning module 423 to continually optimize resource usage in the host system 100 by routine recalculation of the provisioning parameters of the previously provisioned current VMs 107.

Such continuous provisioning calculation not only serves to promote continuous provisioning of the current VMs 107 on most suitable or “best fit” host servers 104, e.g., in accordance with the example algorithm described above, taking into account provisioning of new VMs 107 and/or removal or termination of some current VMs 107, but also ensures VM distribution on the resources based on actual resource usage, rather than on the volume of reserved resources specified in associated VM requests 123. It is thus possible that a new VM is provisioned on a particular combination of host servers 104 based on the requested resource requirements, but that the VM 107 actually, once deployed, uses less resources than requested, and that a more optimal provisioning scheme might have been possible if provisioning calculations were based on actual resource usage. Routine provisioning recalculation accounts for such situations.

A more optimal arrangement, in this example, may include provisioning schemes in which the VM 107 is deployed with fewer scheduled movements, or in which the host system 100 has a greater number of vacant host servers 104.

The method 200 may thus comprise, at 259, initiating recalculation of the current VM 107's provisioning parameters. Thereafter, provisioning parameters are recalculated, starting at 263, for all current VMs 107 that are on unmarked host servers 104. The provisioning parameters for each of these current VMs 107 may then be calculated in a manner similar or analogous to the initial provisioning calculation described earlier herein. The following description of the recalculation operation is limited to certain emphasized differences between initial provisioning and reprovisioning. For clarity of description and illustration, process flow lines that pertain in the flowchart of FIG. 2 exclusively to recalculation of provisioning parameters are shown as chain-dotted lines (with single dots).

The recalculation process may include, at 267, determining whether or not the relevant list of candidate host servers 104 comprises only the server 104 on which the VM 107 under consideration is currently deployed and, if so, keeping the current provisioning parameters of the VM 107, at 271. Note that such a candidate list may either be a list of candidate full-time servers or, if no single-server deployment is feasible, a list of candidate part-time servers for a particular hour. Although the determination, at 267, is shown in FIG. 2 to be performed only subsequent to initial generation of the relevant candidate list, the same consideration may be applied throughout the recalculation process, e.g., after operations 221 and 225.

Suitability factors are calculated, at 227, for all host servers 104 on the relevant candidate list, and an automated selection of host server 104 is made, at 273, based at least in part on the calculated suitability factors. Analysis of the actual usage data for recalculation of the provisioning parameters of the target VM 107 (i.e., the particular current VM 107 under consideration) may include actual usage and capacity of the target VM 107, and/or may exclude resource usage for marked servers 104.

Host server selection, at 273, may be based not only on suitability factor, but may include consideration of designated host servers 104 for hours other than the one being considered. In this example, preference may be given to the server 104 that is next in the deployment schedule for the target VM 107, if any. For example, if, say, host server 104b has the highest suitability factor for a particular hour, but host server 104d is scheduled to host the target VM 107 for the next hour and is on the candidate list for the particular hour, then host server 104d may be selected, at 273, for the particular hour even though it has a lower suitability factor than host server 104b.

If is thereafter determined, at 277, that the selected candidate server 104 is different from the current host of the target VM 107, then the target VM 107 is provisioned on the newly selected server 104, at 281, by changing the provisioning parameters of the target VM 107. Otherwise, the provisioning parameters are left unchanged, at 271.

Other circumstances that may give rise to re-provisioning of a current VM 107 is when actual resource usage of the relevant VM 107 exceeds or appears imminently to exceed the available resources therefor. Because the VM 107 may have been provisioned on its current host server 104, e.g. during the reprovisioning process, based not on the requested resource caps or requested resource reservations, but based on actual usage, there may be instances where resources that are to be consumed by the VM 107 are less than that which is available on that host server 104, even though the VM 107 does not use more resources than requested. Such a resource shortage may also exist due to increased resource usage of other VMs 107 on the same host server 104, relative to their actual past usage.

The method 200 may thus include monitoring resource usage of the respective VMs 107, (e.g., being combined with previously described data mining operations), and raising an alert when an actual, predicted, or imminent resource limit violation by any current VM 107 is detected.

When such a VM resource usage alarm is received, at 285, it may first be established, at 289, whether or not the alert is caused by resource consumption of the relevant VM 107 (which becomes the “target VM” for provisioning calculation purposes) at or above the requested resource reservation. If so, the VM 107 is at fault, and an alert may be sent, at 293, to the corresponding client to warn of excessive resource consumption. If, on the contrary, the target VM 107 is not involved in excessive resource consumption, then provisioning calculations similar to those previously described herein may be performed for the target VM 107.

For ease of description, process flow lines that relate exclusively to reprovisioning responsive to a resource limit alarm are shown in FIG. 2 as double-dotted chain-dotted lines. Such reprovisioning progresses similarly to the routine recalculation of provisioning parameters for current VMs 107 described earlier, although provisioning of the target VM 107 on its current host server 104 is not an option (its current location being a cause of the alarm).

A candidate list of hosts may thus be generated, at 217, first for the whole deployment window and then for each hour of deployment, if necessary. After calculation of respective suitability factors, at 227, a new host server 104 is selected, at 273, based on the lowest suitability factor (with preference for the next host server 104, if any, in the relevant hosting schedule), and the target VM 107 is re-provisioned on its selected new host server 104, at 281.

A more specific example of automated provisioning based on actual usage data, each in accordance with the example method 200, will now be described. Consider an example in which four VM requests 123 are received, in sequence, as follows:

| | | Memory | Storage | |
|---|---|---|---|---|
| # | CPU (vCPU) | (GB) | (GB) | Timings |
| 1 | 2 | 2 | 20 | 6 AM-2 PM |
| 2 | 2 | 3 | 20 | 3 PM-2 AM |
| 3 | 2 | 2 | 25 | 2 A.M-4 AM |
| 4 | 2 | 2 | 15 | 6 AM-3 PM |

For the purposes of this example, consider a host system 100 having only two host servers, 104a and 104b on which the four requested VMs are to be provisioned. The host server 104a and the host server 104b, in this example, each has resource capacities configured as: 4 vCPU, 4 GB RAM (memory) and 40 GB Hard disk (storage).

When the request for the first VM is received, the VM may be provisioned on the host server 104a. This leaves the available resources on host server 104a as 2 vCPU, 2 GB RAM, and 20 GB HD for the time period of 6 A.M to 2 PM, while host server 104a is fully free for the rest of the time of the day.

When the second VM request is received, it is found that the requested resources are available on both host server 104a and host server 104b. However, because, host server 104b is completely unutilized, it may be excluded from consideration (e.g. by being removed from a candidate host server list, such as at operation 225 in FIG. 2). Accordingly, the second VM 107 is also provisioned on host server 104a. The remaining available resources of host server 104a is 2 vCPU, 2 GB RAM, and 20 GB HD for the timeslot of 6 AM to 2 PM, and 2 vCPU, 1 GB RAM and 20 GB HD for the time period of 3 PM to 2 AM

Likewise, when the third request is received, it is found that the requested resources are available on both host server 104a and host server 104b for the target deployment window (2 AM-4 AM), but that host server 104b is unused. The third VM 107 is therefore also provisioned on host server 104a.

Similarly, it may be verified from the VM resource database 113 when the fourth VM request 123 is received, that the required resources are available on both host server 104a and host server 104b in the target deployment window (6 AM-3 PM), but that host server 104b is unused. Thus, the fourth VM 107 is, again, provisioned on host server 104a.

From the above example, it can be seen that performing provisioning based on a sub-daily timescale, e.g. by calculating provisioning parameters for respective hours in the day, instead of considering the daily period as a globular scheduling unit, allows host server 104a to have sufficient resources to host all the requests, even though the total requested resources are greater than the resource capacity of host server 104a. In some existing provisioning schemes, the fact that, for example, the example VM requests require a total CPU capacity of 8 vCPU, while host server 104a has a CPU capacity of 4 vCPU, would have precluded scheduling of all of the requested VMs 107 on host server 104a.

After the above-described initial provisioning, the actual resource usage of the provisioned VMs 107 is monitored, e.g. by the data mining module 431, to analyze resource utilization by all the current VMs 107 on the host system 100. The data mining may discover that the amounts of resources used the for example VMs 107 are different from that which was requested. Consider, for example, the following actual resource usage of the example VMs 107:

| | CPU | Memory | Storage | |
|---|---|---|---|---|
| # | (vCPU) | (GB) | (GB) | Timings |
| 1 | 2 | 1 | 15 | 6 AM-11 AM |
| | 1 | 1 | 15 | 11 AM-1 PM |
| 2 | 1 | 1 | 15 | 3 PM-8 PM |
| | 1 | 2 | 20 | 8 PM-1 AM |
| | 1 | 1 | 10 | 1 AM-2 AM |
| 3 | 2 | 1 | 15 | 2 A.M-4 AM |
| 4 | 1 | 1 | 15 | 6 AM-12 Noon |
| | 1 | 1 | 15 | 12 Noon-2 PM |

If a fifth VM request is then received with resource requirements of 1 vCPU, 2 GB of memory and 10 GB of storage for a deployment window of 11 AM-4 PM, these resource requirements may be compared to the available resources of the host servers 104a and 104b. The resources utilized by host server 104a in the deployment window, as determined based on the actual usage data, is as follows:

| Time | CPU | Memory | Storage |
|---|---|---|---|
| 11 AM-12 Noon | 2 | 2 | 30 |
| 12 Noon-1 PM | 2 | 2 | 30 |
| 1 PM-2 PM | 1 | 1 | 15 |
| 3 PM-4 PM | 1 | 1 | 15 |

Thus, the fifth VM request can also be provisioned on host server 104a, which would not have been possible if provisioning were done with reference to the volumes of resources reserved based on the values specified in the respective VM requests. Instead, the resource consumption of the VMs over a length of time was analyzed, and it was determined that the VMs actually consume different amounts of resources at respective hours of the day than that which was specified by the user. The data mining and automated provisioning based on actual resource usage data in the above example thus exposed spare resources on the host server 104a, and made use of the spent resources in provisioning for the VMs.

### Example Environment Architecture

FIG. 3 is a schematic network diagram that shows an example environment architecture 300 in which an example embodiment of the host system 100 of FIG. 1 may be implemented.

The example architecture 300 of FIG. 3 comprises a client-server architecture in which an example embodiment of the VM provisioning system 111 may be provided. Note that the example environment architecture 300 illustrated with reference to FIGS. 3 and 4 is only one of many possible configurations for employing the features of this disclosure. Thus, in other embodiments, a system providing similar or analogous functionalities to those described below with reference to the example system 111 may be provided by a freestanding general purpose computer executing software to execute automated operations for VM provisioning, as described.

In the embodiment of FIG. 3, the VM provisioning system 111 provides server-side functionality, via a network 115 (e.g., via the Internet, a Wide Area Network (WAN), or a Local Area Network (LAN)) to one or more client machines. FIG. 3 illustrates, for example, a web client 206 (e.g., a browser, such as the Internet Explorer browser developed by Microsoft Corporation of Redmond, Wash.) executed on the associated client machine 119 that is, in this example, configured to access a VM 107 that provides a remote desktop to a user of the client machine 119. A further client machine 312 executes a programmatic client 308, for example to perform remote resource management via the VM provisioning system 111.

An Application Program Interface (API) server 314 and a web server 316 are coupled to, and provide programmatic and web interfaces respectively to, one or more application servers 318. The application servers 318 host one or more VM provisioning application(s) 320 (see also FIG. 3). The web client 306 may access the VM provisioning application(s) 320 via a web interface supported by the web server 316. Similarly, the programmatic client 308 may access the various services and functions provided by the VM provisioning application(s) 320 via a programmatic interface provided by the API server 314.

The application server(s) 318 are, in turn, connected to one or more database server(s) 324 that facilitate access to one or more database(s) 326 that may include information that may be consumed in calculating provisioning parameters for the VMs. In this example, the database(s) 326 provides a VM resource database storing actual usage data and operating parameters of a VM host platform 323 that provides a VM host system 100. The database(s) 326 may thus store information similar or analogous to that described with reference to VM resource database 113 in FIG. 1.

The VM provisioning system 111 may also be in communication with a VM host platform 323 that provides the physical infrastructure for the host system 100, the physical infrastructure comprising a plurality of host servers 104. The VM host platform 323 may have an IT infrastructure comprising multiple IT components.

In this example, each host server 104 is shown as being provided with VM implementation software 346 that, when executed, implements one or more VMs 107 on the host server 104. Each host server 104 is also shown as having associated dedicated server memory 350, which may include RAM and disk storage. In some embodiments, the VM host platform 323 may also provide shared storage memory for use by multiple host servers 104. The VM host platform 323 may comprise a large number of process servers host servers 104, although, for clarity of illustration, FIG. 3 shows only two such host servers 104.

The VM provisioning application(s) 320 may provide a number of automated functions for provisioning VMs on a physical infrastructure and may also provide a number of functions and services to users that access the system 111, for example providing analytics, diagnostic, predictive and management functionality relating resource usage and VM provisioning.

Respective hardware-implemented modules and components for providing functionalities related to automated VM provisioning are described below with reference to FIG. 4. While all of the functional modules, and therefore all of the VM provisioning application(s) 320 are shown in FIG. 3 to form part of the VM provisioning system 111, it will be appreciated that, in alternative embodiments, some of the functional modules or VM provisioning applications may form part of systems that are separate and distinct from the VM provisioning system 111, for example to provide outsourced VM provisioning and/or management.

Again, note that although the example system 111 shown in FIG. 3 employs a client-server architecture, the example embodiments are not limited to such an architecture, and could equally well find application in distributed or peer-to-peer architecture systems, for example. The VM provisioning application(s) 320 could also be implemented as standalone software programs associated with the host system 100, and which do not necessarily have networking capabilities.

### VM Provisioning Application(s)

FIG. 4 is a schematic block diagram illustrating multiple functional modules of the VM provisioning application(s) 320 in accordance with one example embodiment. As mentioned, the example modules are illustrated as forming part of a single application, but they may be provided by a plurality of separate applications. The modules of the application(s) 320 may be hosted on dedicated or shared server machines (not shown) that are communicatively coupled to enable communication between server machines. At least some of the modules themselves are communicatively coupled (e.g., via appropriate interfaces) to each other and to various data sources, to allow information to be passed between the modules or to allow the modules to share and access common data. The modules of the application(s) 320 may furthermore access the one or more databases 326 via the database server(s) 324.

In this example, the VM provisioning application(s) 320 provides the various functionalities for performing in the example method 200 illustrated in FIG. 2. Accordingly, the functionalities of the respective modules and components of the VM provisioning application(s) 320 may be understood with reference to the description of the example method 200 and are not repeated in the description that follows

The VM provisioning application(s) 320 provide a user interface module 407 for, inter alia, receiving input from user via associated client machines 119, 312. In particular, the user interface module 407 may be configured to receive VM requests 123 that indicate resource requirement attributes specifying resource requirements for a target VM that is to be implemented on the VM host platform 323.

A provisioning module 411 may be provided to perform automated determination of provisioning parameters for the requested target VM based at least in part on actual usage data and the specified resource requirement attributes.

Thus, the provisioning module 411 may cooperate with (or in some embodiments include) a candidate list generator 413 to generate a list of candidate host servers, and a suitability calculator 419 to calculate suitability factors for the respective candidate host servers. The candidate list generator 413 and the suitability calculator 419 may use past resource usage data and/or resource availability data in performing their respective functions. This information may, at least in part, be generated or discovered on a continuous basis by a data mining module 431. The data mining module 431 be configured not only to gather and collect the actual usage data, but also to parse and compile the raw data to produce daily resource usage distribution (e.g., a daily resource usage pattern) for each VM and/or each host server.

The candidate list and associated suitability factors may be used by the provisioning module 411 to select a particular host server 104 on which the requested target VM is to be deployed, and to effect implementation of the target VM 107 by reserving the allocated resources on the selected host server 104.

The VM provisioning application(s) 320 may further include a post-deployment provisioning module 423 which provides functionality similar to that of the provisioning module, with the distinction that the provisioning calculations and deployment operations of the post-deployment provisioning module 423 are performed with respect to current VMs 107 which have already been provisioned and deployed.

The VM provisioning application(s) 320 may further include a server marking module 429 to mark host servers 104 whose resources are sufficiently consumed (based on actual resource usage) by one or more current VMs 107 hosted thereon.

### Higher-Level Example Embodiment

FIG. 5 is a high-level entity relationship diagram of another example embodiment of a VM provisioning system 500. The system 500 may include one or more computer(s) 533 that comprise a provisioning module 544 to provision virtual machines on a physical platform.

The system 500 also includes one or more memories, e.g. process databases, in which is stored actual usage data indicating past resource usage of a plurality of virtual machines currently hosted on the physical infrastructure, and resource requirement attributes indicating resource requirements for a target virtual machine that is to be deployed on the physical infrastructure.

The provisioning module 544 is configured to calculate provisioning parameters 555 for the target virtual machine based at least in part on the actual usage data 522 and the resource requirement attributes 511. The provisioning module 544 may also be configured to provision virtual machines on the physical infrastructure in respective daily timeslots.

Note that although the system 500 is shown, for ease of illustration, to have a single computing device 104 and separate memories for the actual usage data 522 and resource requirement attributes 511, the elements of system 500 may, in other embodiments, be provided by any number of cooperating system elements, such as processors, computers, modules, and memories, that may be geographically dispersed or that may be on-board components of a single unit.

FIG. 6 shows a high-level flowchart of another example method 600 to provision VMs on a physical infrastructure, which may be implemented by the system 500. The method 600 comprises receiving, at 612, resource requirement attributes indicating resource requirements for a target virtual machine to be deployed on a host system comprising a plurality of physical host servers, and accessing one or more memories storing actual usage data indicating past resource usage of a plurality of current VMs on the host system. The method 600 thereafter includes, in an automated operation using one or more processors, calculating provisioning parameters for the target VM based at least in part on the actual usage data and the resource requirement attributes.

In other embodiments, a system and method analogous to those described above may have a number of further features, operations, and/or components. For example, the actual usage data may comprise, for respective host servers, resource usage distribution that indicate past resource consumption by one or more associated current VMs over multiple time units of a regularly repeating scheduling period. Such resource usage distribution may indicate, for the respective host servers, past resource consumption for multiple time units of a daily scheduling period, e.g. for respective hours of the day.

The resource requirement attributes may include a deployment window comprising a defined portion of the scheduling period for which hosting of the target VM is required, the deployment window spanning one or more of the time units, e.g., spanning a number of hours of the day.

Calculation of the provisioning parameters may be such that it is biased against provisioning the target VM on a host server on which no current VM is provisioned. Instead, or in addition, the provisioning module may be configured to perform calculation of the provisioning parameters such that it is biased against movement of the target VM from one host server to another during the scheduling period.

A candidate list generator may, for example, be provided to generate a list of candidate host servers for the target VM, each candidate host server having sufficient available resources throughout the deployment window to satisfy the resource requirements of the target VM, the available resources of the plurality of host servers being determined based at least in part on the actual usage data, and in part on a resource capacity of each of the plurality of host servers.

One or more currently unused host servers may automatically be excluded from the list of candidate host servers. The method may include in such a case include identifying the one or more currently unused host servers by determining, for each unused host server, that the total available resources of the host server are equal to the total resource capacity of that host server.

A suitability calculator may be provided to determine a most suitable candidate host server from the list of candidate host servers, a particular candidate host server being selected for deployment of the target VM based at least in part on determination of the most suitable candidate host server.

Instead, or in addition, the suitability calculator may calculate a suitability factor for each of the candidate host servers, a particular candidate host server being selected for deployment of the target VM based at least in part on the calculated suitability factors. The suitability factor may be based at least in part on a total number of continuous time units in the scheduling period for which the available resources of the relevant candidate host server satisfies the resource requirements of the target VM. In one example embodiment, favorability of the suitability factor increases with a decrease in its magnitude. The suitability factor may, for example, correspond to the product of:
a total number of continuous time units per scheduling period for which the available resources of the relevant candidate host server satisfies the resource requirements of the target VM;
a difference between total resources of the relevant candidate host server and a total amount of resources consumed by all VMs deployed on the relevant host server over the scheduling period; and
available resources of the relevant candidate host server in the deployment window.

Responsive to determining that the candidate list is an empty set, deployment of the target VM may automatically be scheduled on two or more part-time host servers in distinct respective deployment intervals. To this end, a list of candidate part-time host servers may be generated for each of the time units in the deployment window, and the suitability of the respective candidate part-time host servers in the respective candidate lists may be determined for each of the time units in the deployment window. In some embodiments, determining of the suitability of part-time host servers may be performed, for each time unit, in a manner similar or analogous to the determination of the suitability of candidate host servers for the full scheduling period in instances where the list of candidate host servers is not an empty set.

The term “part-time host server”, as opposed to “host server” indicates that the relevant host server is one of the plurality of host servers on which the target VM is to be implemented in respective deployment intervals, but note that the part-time host server forms part of the plurality of host servers that provide the host system. A single host server may thus serve both as a part-time host server on which one or more VMs are deployed for part of their deployment windows, while at the same time also serving as a host server on which one or more VMs are deployed for the whole of their deployment windows.

The provisioning module may be configured to bias automatic scheduling of the target VM on the two or more part-time host servers towards fewer instances of motion of the target VM between part-time host servers within the deployment window. The provisioning module may, for example be configured to determine, responsive to scheduling deployment of the target VM on a particular part-time host server for a particular time unit, whether the particular part-time host server has sufficient available resources for an immediately succeeding time unit, and, responsive to the determination being in the positive, to schedule the particular part-time host server as host for the target VM for said succeeding time unit, regardless of any other factors relevant to part-time host server suitability.

The target VM may be a current VM that is already implemented on the host system, the resource requirement attributes being indicated by actual past resource usage of the target VM. A post-deployment provisioning module may be provided for this purpose, for example, by determining whether or not the calculated provisioning parameters are different from current provisioning parameters of the target VM, and, responsive to the determination being in the positive, redeploying the target VM based on the calculated provisioning parameters.

Provisioning parameters may routinely, e.g., continuously, be recalculated for all current VMs, except for one or more current VMs that are marked for exclusion from routine recalculation. A server marking module be provided to routinely (e.g., continuously) process resource usage of the plurality of current VMs, and responsive to determining that one or more host servers have no available resources, to mark the one or more host servers for exclusion from routine recalculation.

A data mining module 431 be provided to routinely (e.g., continuously) discover operating parameters of the host system, the operating parameters including actual resource usage by the plurality of current VMs, and to routinely update the actual usage data.

It is a benefit of the example method and systems described herein that it provides for automated provisioning that achieves superior mapping of physical servers to VMs. This applies not only to new VMs, but to also to VMs already deployed on the system. This may be achieved while improving resource utilization and additionally reducing the number of live migrations, or vMotions, of the VMs.

In instances where a multi-server deployment is scheduled, it is beneficial that the motion of the VM between the respective part-time servers is scheduled in advance for particular times, thereby facilitating more accurate and realistic scheduling of resource usage.

### Modules, Components, and Logic of Example Embodiments

Certain embodiments are described herein as including logic or a number of components, modules, or mechanisms. Modules may constitute either software modules, with code embodied on a non-transitory machine-readable medium (i.e., such as any conventional storage device, such as volatile or non-volatile memory, disk drives or solid state storage devices (SSDs), etc.), or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry or in temporarily configured circuitry (e.g., configured by software), may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

FIG. 7 shows a diagrammatic representation of a machine in the example form of a computer system 700 within which a set of instructions, for causing the machine to perform any one or more of the methodologies discussed herein, may be executed. For example, the system 100 (FIG. 1) or any one or more of its components (FIGS. 1 and 2) may be provided by the system 700.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alpha-numeric input device 712 (e.g., a keyboard), a cursor control device 714 (e.g., a mouse), a disk drive unit 716, an audio/video signal input/output device 718 (e.g., a microphone/speaker) and a network interface device 720.

The disk drive unit 716 includes a machine-readable storage medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting non-transitory machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database and/or associated caches and servers) that store the one or more sets of instructions. The term “machine-readable medium” shall also be taken to include any medium that is capable of storing a set of instructions for execution by the machine and that cause the machine to perform any one or more of the methodologies of this disclosure. The term “machine-readable medium” shall accordingly be taken to include, but not be limited to, solid-state memory devices of all types, as well as optical and magnetic media.

Thus, a system and method to provision VMs on a physical infrastructure have been described. Although these methods and systems have been described with reference to specific example embodiments, it will be evident that various modifications and changes may be made to these embodiments without departing from the broader spirit and scope thereof. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the disclosed subject matter lies in less than all features of a single disclosed embodiment. Thus, the following claims are hereby incorporated into the Detailed Description, with each claim standing on its own as a separate embodiment.

What is claimed is:

1. A method comprising:
receiving resource requirement attributes indicating resource requirements for a target virtual machine (VM) to be deployed on a host system comprising a plurality of physical host servers;
accessing one or more memories storing actual usage data indicating past resource usage of a plurality of current VMs hosted on the host system;
in an automated operation using one or more processors, calculating provisioning parameters for the target VM based at least in part on the actual usage data and the resource requirement attributes.

2. The method of claim 1, wherein the actual usage data comprises, for respective host servers, resource usage distribution that indicate past resource consumption by one or more associated current VMs over multiple time units of a regularly repeating scheduling period.

3. The method of claim 2, wherein the resource usage distribution indicates, for the respective host servers, past resource consumption for multiple time units of a daily scheduling period.

4. The method of claim 2, wherein the resource requirement attributes include a deployment window comprising a defined portion of the scheduling period for which hosting of the target VM is required, the deployment window spanning one or more of the time units.

5. The method of claim 4, wherein the calculating of the provisioning parameters includes generating a list of candidate host servers for the target VM, each candidate host server having sufficient available resources throughout the deployment window to satisfy the resource requirements of the target VM, the available resources of the plurality of host servers being determined based at least in part on
the actual usage data, and
a resource capacity of each of the plurality of host servers.

6. The method of claim 5, further comprising excluding one or more currently unused host servers from the list of candidate host servers.

7. The method of claim 5, further comprising:
in an automated operation, determining a most suitable candidate host server from the list of candidate host servers; and
selecting the most suitable candidate host server for deployment of the target VM.

8. The method of claim 5, wherein the selecting of the particular host server comprises calculating a suitability factor for each of the candidate host servers, and selecting the particular candidate host server having a most favorable suitability factor, the suitability factor being based at least in part on a total number of continuous time units in the scheduling period for which the available resources of the relevant candidate host server satisfies the resource requirements of the target VM.

9. The method of claim 8, wherein favorability of the suitability factor increases with a decrease in its magnitude, the suitability factor corresponding to the product of:
a total number of continuous time units per scheduling period for which the available resources of the relevant candidate host server satisfies the resource requirements of the target VM;
a difference between total resources of the relevant candidate host server and a total amount of resources consumed by all VMs deployed on the relevant host server over the scheduling period; and
available resources of the relevant candidate host server in the deployment window.

10. The method of claim 5, further comprising:
determining that the list of candidate host servers is an empty set: and
responsive to the determination, automatically scheduling deployment of the target VM on two or more part-time host servers in distinct respective deployment intervals that together cover the deployment window, the automatic scheduling comprising,
for each of the time units in the deployment window, generating a list of candidate part-time host servers, and
for each of the time units in the deployment window, determining the suitability of the respective candidate part-time host servers.

11. The method of claim 4, wherein the target VM is a current VM that is already implemented on the host system, the resource requirement attributes being indicated by actual past resource usage of the target VM, the method further comprising:
determining whether or not the calculated provisioning parameters are different from current provisioning parameters of the target VM; and
responsive to the determination being in the positive, redeploying the target VM based on the calculated provisioning parameters.

12. The method of claim 11, further comprising routinely recalculating provisioning parameters for all of the plurality of current VMs, except for one or more current VMs that are marked for exclusion from routine recalculation.

13. The method of claim 12, further comprising:
routinely processing resource usage of the plurality of current VMs; and
responsive to determining that one or more host servers have no available resources, marking the one or more host servers for exclusion from routine recalculation.

14. The method of claim 1, further comprising continually discovering operating parameters of the host system, and continually updating the actual usage data.

15. A system comprising:
one or more memories to store
resource requirement attributes indicating resource requirements for a target virtual machine (VM) to be deployed on a host system comprising a plurality of physical host servers, and
actual usage data indicating past resource usage of a plurality of current VMs hosted on the host system; and
one or more processors that comprise a hardware-implemented provisioning module to calculate provisioning parameters for the target VM based at least in part on the actual usage data and the resource requirement attributes.

16. The system of claim 15, wherein the actual usage data comprises, for respective host servers, resource usage distribution that indicate past resource consumption by one or more associated current VMs over multiple time units of a regularly repeating scheduling period.

17. The system of claim 16, wherein the resource requirement attributes include a deployment window comprising a defined portion of the scheduling period for which hosting of the target VM is required, the deployment window spanning one or more of the time units.

18. The system of claim 17, wherein the provisioning module is configured to perform calculation of the provisioning parameters such that it is biased against provisioning the target VM on a host server on which no current VM is provisioned.

19. The system of claim 17, wherein the provisioning module is configured to perform calculation of the provisioning parameters such that it is biased against movement of the target VM from one host server to another during the scheduling period.

20. The system of claim 17, wherein the provisioning module includes a candidate list generator to generate a list of candidate host servers for the target VM, each candidate host server having sufficient available resources throughout the deployment window to satisfy the resource requirements of the target VM, the available resources of the plurality of host servers being determined based at least in part on
the actual usage data, and
a resource capacity of each of the plurality of host servers.

21. The system of claim 20, further comprising a suitability calculator to determine a most suitable candidate host server from the list of candidate host servers, the provisioning module being configured to select a particular candidate host server for deployment of the target VM based at least in part on determination of the most suitable candidate host server.

22. The system of claim 20, further comprising a suitability calculator to calculate a suitability factor for each of the candidate host servers, the provisioning model being configured to select a particular candidate host server for deployment of the target VM based at least in part on the calculated suitability factors, the suitability factor being based at least in part on a total number of continuous time units in the scheduling period for which the available resources of the relevant candidate host server satisfies the resource requirements of the target VM.

23. The system of claim 20, wherein the provisioning module is further configured to:
determine that the list of candidate host servers is an empty set: and
responsive to the determination, to automatically schedule deployment of the target VM on two or more part-time host servers in distinct respective deployment intervals by,
for each of the time units in the deployment window, generating a list of candidate part-time host servers, and
for each of the time units in the deployment window, determining the suitability of the respective candidate part-time host servers.

24. The system of claim 23, wherein the provisioning module is configured to bias automatic scheduling of the target VM on the two or more part-time host servers towards fewer instances of motion of the target VM between part-time host servers within the deployment window.

25. The system of claim 24, wherein the provisioning module is configured to determine, responsive to scheduling deployment of the target VM on a particular part-time host server for a particular time unit, whether the particular part-time host server has sufficient available resources for an immediately succeeding time unit, and, responsive to the determination being in the positive, to schedule the particular part-time host server as host for the target VM for said succeeding time unit, regardless of any other factors relevant to part-time host server suitability.

26. The system of claim 17, wherein the target VM is a current VM that is already implemented on the host system, the resource requirement attributes being indicated by actual past resource usage of the target VM, the system further comprising a post-deployment provisioning module to:
determine whether or not the calculated provisioning parameters are different from current provisioning parameters of the target VM; and
responsive to the determination being in the positive, redeploying the target VM based on the calculated provisioning parameters.

27. The system of claim 15, further comprising a data mining module to routinely discover operating parameters of the host system, the operating parameters including actual resource usage by the plurality of current VMs, and to routinely update the actual usage data.

28. A non-transitory machine-readable storage medium storing instructions which, when performed by a machine, cause the machine to:
access resource requirement attributes stored in one or more memories, the resource requirement attributes indicating resource requirements for a target virtual machine (VM) to be deployed on a host system comprising a plurality of physical host servers;
access actual usage data stored in the one or more memories, the actual usage data indicating past resource usage of a plurality of current VMs hosted on the host system;
calculate provisioning parameters for the target VM based at least in part on the actual usage data and the resource requirement attributes.
